(19) United States
(12) Patent Application Publication
(10) Pub. No.: US 2007/0028711 A1
(43) Pub. Date: Feb. 8, 2007

(54) Device for pressing a gear rack against a pinion meshing with the gear rack

(76) Inventors: Olaf Beutler, Diepholz (DE); Christian Karch, Taeferrot (DE)

Correspondence Address: KENYON & KENYON LLP, ONE BROADWAY, NEW YORK, NY, 10004, US

(21) Appl. No.: 11/286,212

(22) Filed: Nov. 22, 2005

(30) Foreign Application Priority Data
Nov. 26, 2004 (DE) 10 2004 057 160.0

(51) Int. Cl. F16H 1/04; F16H 55/18

(52) U.S. Cl. 74/409; 74/422

(57) ABSTRACT

A device for pressing a gear rack against a pinion meshing with the gear rack, e.g., in a rack-and-pinion steering system for a motor vehicle, includes a thrust piece, which is loaded by a spring in the direction of the gear rack and is slidably guided in a housing. The thrust piece takes the form of a sintered part, which has a plurality of depressions on its circumferential surface. The regions of the circumferential surface, which are elevated with respect to the depressions, produce the contact of the thrust piece with the housing.

### FIELD OF THE INVENTION

The present invention relates to a device for pressing a gear rack against a pinion meshing with the gear rack, e.g., in a rack-and-pinion steering system for a motor vehicle. The present invention also relates to a rack-and-pinion steering system.

### BACKGROUND INFORMATION

German Published Patent Application No. 197 17 797 describes a rack-and-pinion steering system for motor vehicles, which has a gear rack, a pinion meshing with the gear rack, and a generic device for pressing the gear rack against the pinion. Such rack-and-pinion steering systems normally have a steering box, in which the gear rack is supported so as to be longitudinally displaceable. The pinion rotationally mounted in the steering box meshes with the gear teeth of the gear rack and causes the gear rack to be laterally displaced in response to the rotation of the steering column connected to the pinion in a rotatably fixed manner. The gear rack, in turn, causes the steered wheels of the motor vehicle to swivel via tie rods and steering knuckles, and therefore effects a change in direction of the vehicle desired by the driver.

The mating of the pinion with the gear rack is kept backlash-free in that, under the initial stress of a spring, a thrust piece resting against the gear rack, opposite to the pinion, presses the gear rack against the pinion and, in this manner, limits the backlash between the gear teeth of the parts involved. In addition, the thrust piece has the task of absorbing the repelling forces generated during the steering and dissipating them via the housing in which the thrust piece is slidably supported. In order to prevent irritating noises, the thrust piece should also be capable of adjusting to the gear-tooth wear of the parts involved, as well as to the wear of any inserted thrust-piece foil. The play of the thrust piece is adjusted via a setscrew, which is screwed to the housing and controls the initial spring force as well.

The thrust piece should also be arranged such, or should press against the gear rack such, that the coupling of the gear rack and the pinion may be maintained without play in the meshing teeth. In this context, imperfections regarding the eccentricity of the pinion, its axial play, and the wear of the teeth should be taken into account. In addition, the device should be capable of enduring shocks coming from the steered wheels without damage when, for example, they strike an obstacle.

The thrust piece also has the task of compensating for both the tolerances between the gear rack and the pinion and the movement occurring between these parts in the case of working error.

The force necessary for displacing the gear rack is determined by, inter alia, the contact pressure of the thrust piece, a lower contact pressure of the thrust piece allowing a lower gear-rack displacement force. On the other hand, repelling forces between the gear rack and the pinion may be considerably greater than the gear-rack displacement force, which means that they should be absorbed by a greater counteracting force on the part of the thrust piece or the spring acting on the same. Therefore, in the case of its mechanical arrangement described in German Published Patent Application No. 197 17 797, the thrust piece should have two characteristics connected in series, for which, e.g., two springs of different rigidities may be used. In the case of conventional thrust pieces, too high a friction between the thrust piece and the housing during rapid load changes may allow the gear rack to rebound into the pinion more rapidly than the thrust piece is able to follow this movement. This allows so-called thrust-piece knock to occur, in which the thrust piece sharply impacts the gear rack and produces a clearly audible noise. This effect may indeed be compensated for by a higher initial stress of the spring acting on the thrust piece, but this increases the force necessary for displacing the gear rack. In addition, the contact of the gear rack with the thrust piece during the translational displacement of the gear rack may cause the thrust piece to tilt about its center line, which may also result in the thrust piece knocking against the housing when the displacement velocities of the gear rack are suitably high. In the case of the mechanical thrust piece described, for example, in German Published Patent Application No. 197 17 797, this is promoted by the centrally positioned thrust-piece spring and the O-ring used for guiding the thrust piece inside the housing. Furthermore, high gear-tooth repelling forces between the pinion and the gear rack may cause the thrust piece to strike against the setscrew acting on the spring from the side opposite the thrust piece. Therefore, the knocking of the thrust piece occurs when the gearing forces are reduced more rapidly than the thrust piece may adjust. However, a higher spring force, which again increases the gear-rack displacement force, may be necessary for adjusting the thrust piece more rapidly.

An option for at least partially satisfying these different requirements follows from a hydraulic thrust piece, such as that described, for example, in German Published Patent Application No. 102 08 948. However, such a hydraulic thrust piece may be very expensive and may require a large amount of extra work.

### SUMMARY

Example embodiments of the present invention may provide a device for pressing the gear rack against a pinion meshing with the gear rack, the device permitting the displacement force of the gear rack to be low and still preventing the thrust piece from knocking against the housing or a housing part, while the device should be able to be manufactured as inexpensively as possible.

By manufacturing the thrust piece as a sintered part, it may be possible to produce structures that are considerably more complex, for example, than in the case of die-cast parts. In this connection, it may be provided that in comparison with a die-casting process, the costs of a sintering process may be more likely to be lower. In the case of a sintered part, the surface structure of the same and, therefore, its coefficient of friction are also able to be determined by the selected grain size. This coefficient of friction, which may have a considerable effect on the rapid adjustment of the thrust piece with respect to the gear rack, may also be improved by admixing lubricating modifiers or other metals with the material of the sintered part.

The depressions in the circumferential surface of the sintered part produce defined, raised regions, which are used as contact regions between the thrust piece and the housing, and by which the friction between the thrust piece and the housing may be more effectively defined. In this manner, the adhesion forces between the thrust piece and the housing may be simultaneously reduced. Therefore, the reduction in the contact surface between the thrust piece and the housing may produce lower adhesion forces, which means that it may be possible for the thrust piece to slide more easily. Thus, the forces applied by the spring to the thrust piece may be reduced, which may result in lower displacement forces for the gear rack and, therefore, lower actuating forces of a rack-and-pinion steering system equipped with a device hereof. The rapid tracking of the thrust piece may prevent the knocking of the thrust piece occurring in conventional devices for pressing the gear rack against the pinion.

The thrust piece may be filled with lubricant, and lifetime lubrication of the thrust piece slidably supported in the housing may be produced. In conjunction with the above-mentioned, defined contact surface between the thrust piece and the housing, this may be utilized to eliminate thrust-piece foils that are otherwise necessary. In addition, channeling of the lubricant from the interior of the thrust piece may provide a low, defined friction between the thrust piece and the housing at each operating point of the device, which means that the thrust piece may be even rapidly adjusted in the case of rapid load changes.

The use of a flat-wire corrugated spring for the spring acting on the thrust piece may prevent the thrust piece from tilting, since such a flat-wire corrugated spring has several support points over its circumference. This means that the force acting from the gear rack upon the spring via the thrust piece may be absorbed much more uniformly than in the case of conventional devices. At the same time, the structure of the flat-wire corrugated spring may also prevent the thrust piece from impacting the housing or a setscrew that occludes the housing.

An additional, the flat-wire corrugated spring may provide a spring characteristic that has a linear characteristic-curve range extending to the nominal operating point of the spring and a progressive characteristic-curve range extending to the limit-stop position of the spring. This type of characteristic curve may allow the device to be adjusted such that the tolerance between the pinion and the gear rack may be compensated for in the linear range of the characteristic, while the significantly higher repelling or gearing forces may be absorbed within the progressive part of the spring characteristic. This may advantageously yield lower displacement forces for the gear rack.

The flat-wire corrugated spring may be multilayered.

Effective results with regard to a low gear-rack displacement force and the elimination of the thrust-piece knock may be attained if a device for pressing a gear rack against a pinion is used, which has a combination of the features described herein.

A rack-and-pinion steering system, e.g., for a motor vehicle, having a gear rack displaceably supported in a housing, a pinion connected to the steering spindle and meshing with the gear rack, and a device for pressing the gear rack against the pinion, is described herein.

Further aspects and features of example embodiments of the present invention are described below with reference to the appended Figures.

### BRIEF DESCRIPTION OF THE DRAWINGS

FIG. 1 is a highly schematic illustration of a rack-and-pinion steering system having a device according to an example embodiment of the present invention.

FIG. 2 is an enlarged view of the device illustrated in FIG. 1.

FIG. 3 illustrates the characteristic curve of a flat-wire corrugated spring illustrated in comparison with a conventional helical spring.

FIG. 4 is a perspective view of a thrust piece.

FIG. 5 is a cross-sectional view taken along the line V-V illustrated in FIG. 4.

FIG. 6 is a cross-sectional view taken along line VI-VI illustrated in FIG. 3.

### DETAILED DESCRIPTION

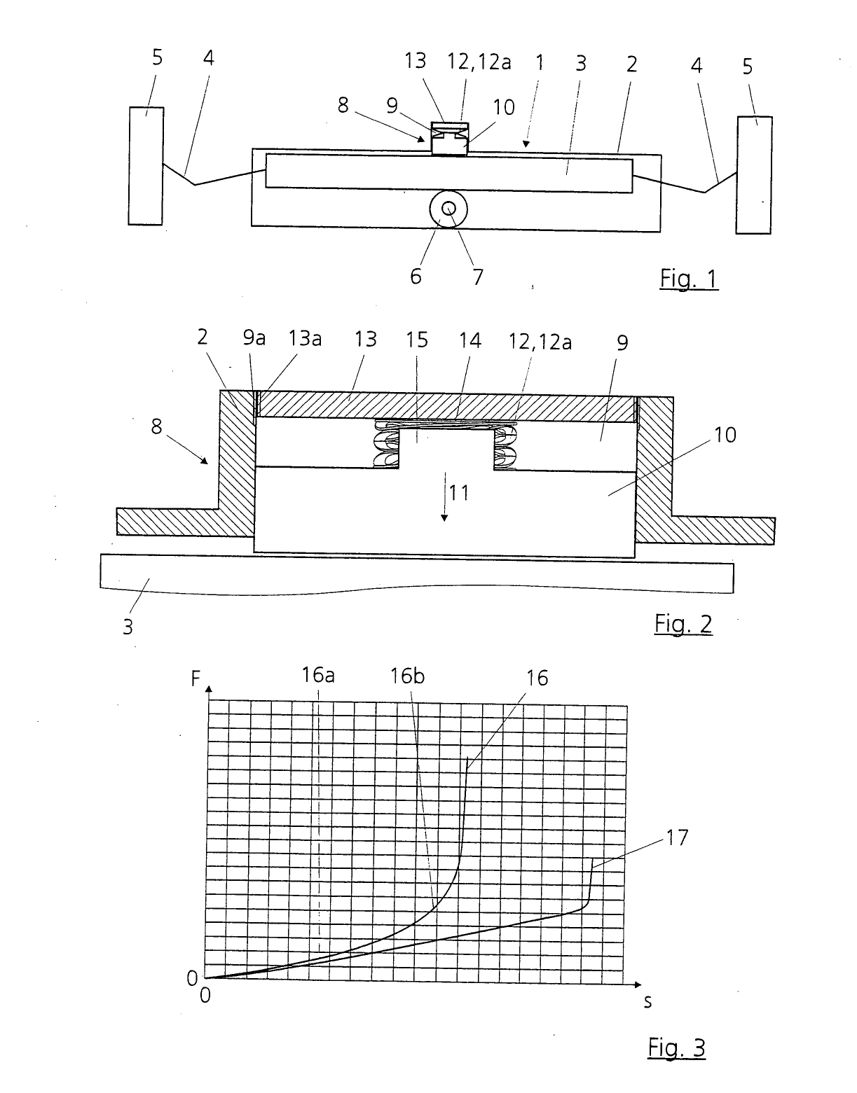

FIG. 1 illustrates, in a highly schematic representation, a rack-and-pinion steering system 1 for a motor vehicle. Rack-and-pinion steering system 1 includes, e.g., in a conventional manner, a housing 2 in which a gear rack 3 is displaceably supported. Gear rack 3, which has a circular cross-section but may have any cross-section, acts on tie rods 4, e.g., in a conventional manner, the tie rods being used for adjusting wheels 5 of the motor vehicle. A pinion 6, which is connected in a rotatably fixed manner to a steering spindle 7 illustrated highly schematically, meshes with gear rack 3 to move the same.

In addition, rack-and-pinion steering system 1 has a device 8 for pressing gear rack 3 against pinion 6, the device having a thrust piece 10 guided in a recess 9 of housing 2, a spring 12 that acts in the axial direction indicated by reference numeral “11” and loads thrust piece 10 in the direction of gear rack 3, as well as a setscrew 13 that occludes recess 9 and acts on spring 12. In this respect, device 8 and its mode of operation are described, e.g., in German Published Patent Application No. 197 17 797 and were described described above.

Device 8 for pressing gear rack 3 against pinion 6 is illustrated in greater detail in FIG. 2. In this context, it is apparent that setscrew 13 has an outer thread 13a, which engages with an inner thread 9a of recess 9 of housing 2. In this manner, setscrew 13, which is provided with, e.g., a slot or similar device on the side facing away from thrust piece 10 that allows a tool to engage with setscrew 13, may be rotated so that the initial stress of spring 12 may be set. At the same time, setscrew 13 is also used as a limit stop for thrust piece 10 that is movable in axial direction 11 inside housing 2, which means that a limit stop for thrust piece 10 may be adjusted by rotating setscrew 13. This limit stop for thrust piece 10 simultaneously protects spring 12 from overload.

In addition, it follows from FIG. 2 that spring 12 acting on thrust piece 10 takes the form of a multilayer, flat-wire corrugated spring 12a. Flat-wire corrugated spring 12a has a central bore 14, with which a projection 15 attached to the side of thrust piece 10 facing away from gear rack 3 engages. Projection 15 is used, first of all, for centering flat-wire corrugated spring 12a on thrust piece 10 and forms, secondly, the part of thrust piece 10 that possibly strikes against setscrew 13 to limit the travel of thrust piece 10. Flat-wire corrugated spring 12a is therefore arranged on projection 15 between thrust piece 10 and setscrew 13.

The multiple support points of flat-wire corrugated spring 12 distributed about it circumference prevent thrust piece 10 from tilting, which means that the by gear rack 3 to flat-wire corrugated spring 12a via thrust piece 10 is absorbed in a highly uniform manner. Flat-wire corrugated spring 12a has a total of four support points distributed about it circumference. The arrangement of flat-wire corrugated spring 12a also prevents thrust piece 10 from striking against setscrew 13.

In FIG. 3, reference numeral 16 represents the spring characteristic of flat-wire corrugated spring 12a in comparison with a spring characteristic 17 of a helical spring, which may be used in conventional rack-and-pinion steering systems. From this diagram, in which force F is plotted versus displacement s of the spring in each case, it follows that spring characteristic 16 of flat-wire corrugated spring 12a has a linear initial-stress range 16a extending to the nominal operating point of the same and a progressive operating range 16b, which extends to the limit-stop position of the same, and in which thrust piece 10 is adjusted. This allows device 8 to be adjusted such that the tolerance between pinion 6 and gear rack 3 may be compensated for in linear region 16a of spring characteristic 16, whereas the considerably higher repelling or gearing forces are absorbed within progressive part 16b of spring characteristic 16, which may result in lower displacement forces for gear rack 3. Therefore, during the operation of thrust piece 10, flat-wire corrugated spring 12a may contribute considerably more to solving the problems described above than a conventional helical spring. In addition, the progressiveness of flat-wire corrugated spring 12a may allow the operating point of the same to be adjusted much more effectively than a helical spring, since the system may be considerably more error-tolerant. And, given the same space, flat-wire corrugated spring 12a may be able to absorb a much higher force than a helical spring.

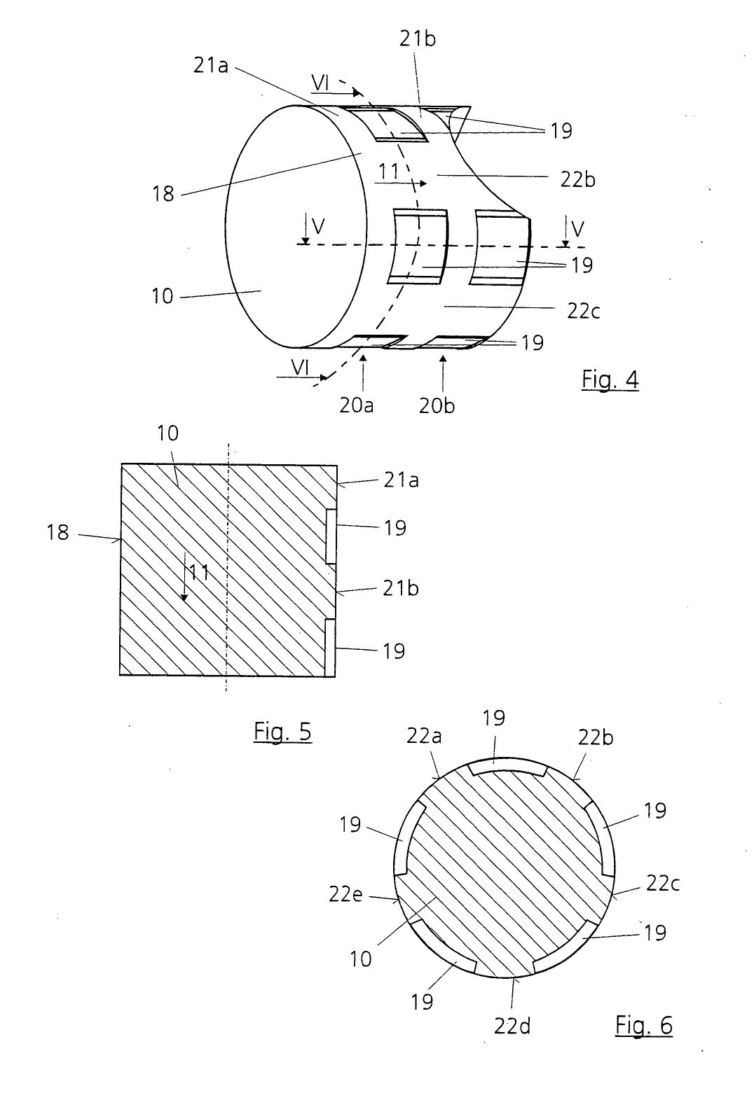

Thrust piece 10 is illustrated in more detail in FIG. 4. Thus, thrust piece 10 takes the form of a sintered part, and on its circumferential surface 18, it has a plurality of depressions 19 that may be introduced into thrust piece 10 during its sintering. In this context, the regions that are elevated with respect to depressions 19 produce the contact of thrust piece 10 with housing 2. In order to allow thrust piece 10 to slide more effectively during its movement in axial direction 11 inside housing 2, thrust piece 10 is filled with a lubricant, e.g., oil. This is rendered possible by forming thrust piece 10 as a sintered part, since such a sintered part is highly porous and may therefore hold a large amount of lubricant in itself. This lubricant is released outwardly by thrust piece 10 over the lifetime of the same, e.g., onto the slideway of recess 9. Since sintering is a conventional process, it will not be discussed any further.

In FIG. 4, it can also be seen that thrust piece 10 has two rows 20a and 20b of depressions 19 in its axial direction 11, of which row 20b facing gear rack 3 extends up to the edge of thrust piece 10 facing gear rack 3. In this manner, the two rows 20a and 20b form two annular projections 21a and 21b, which extend around circumferential surface 18 of thrust piece 10 and produce the contact of thrust piece 10 with housing 2. These two annular projections 21a and 21b may provide considerably improved guidance of thrust piece 10 inside housing 2, the contact at two points or rings preventing thrust piece 10 from tilting about its centerline extending in axial direction 11. The two annular projections 21a and 21b are also represented in the cross-sectional view of FIG. 5.

It is also illustrated in FIG. 4 and the cross-sectional view of FIG. 6 that five depressions 19 are annularly positioned about the circumference of thrust piece 10. This produces five linear projections 22a, 22b, 22c, 22d, and 22e, which extend in axial direction 11 of thrust piece 10, produce the contact of thrust piece 10 to housing 2 as do annular projections 21a and 21b, and may ensure that thrust piece 10 is guided inside housing 2. In this context, linear projections 22a, 22b, 22c, 22d, and 22e act as guide bars.

If the accuracy of fit between thrust piece 10 and recess 9 of housing 2 does not suffice for preventing knocking noises, then a guide sleeve made, for example, out of plastic may be inserted into recess 9, the guide sleeve being able to be calibrated with the aid of thrust piece 10.

Although it may be provided to combine the thrust piece 10 taking the form of a sintered part and having depressions 19, with flat-wire corrugated spring 12a, it is also possible to use flat-wire corrugated spring 12a with a “conventional” thrust piece, which does not have depressions 19 and may be produced, for example, by die-casting. Conversely, thrust piece 10, which takes the form of a sintered part and has depressions 19, may be used together with a conventionally utilized, helical spring.

### LIST OF REFERENCE NUMERALS

1 rack-and-pinion steering system
2 housing
3 gear rack
4 tie rods
5 wheels
6 pinion
7 steering spindle
8 device
9 recess
9a inner thread
10 thrust piece
11 axial direction
12 spring
12a flat-wire corrugated spring
13 setscrew
13a outer thread
14 bore
15 projection
16 spring characteristic
16a linear initial-stress range
16b progressive operating range
17 spring characteristic
18 circumferential surface
19 depression
20a row
20b row
21a annular projection
21b annular projection
22a linear projection
22b linear projection
22c linear projection
22d linear projection
22e linear projection

1-11. (canceled)

12. A device for pressing a gear rack against a pinion meshing with the gear rack, comprising:
a housing;
a spring; and
a thrust piece that is loaded by the spring in a direction of the gear rack and is slidably guided in the housing, the thrust piece arranged as a sintered part having a plurality of depressions on a circumferential surface, regions of the circumferential surface elevated with respect to the depressions providing a contact of the thrust piece with the housing.

13. The device according to claim 12, wherein the device is arranged in a rack-and-pinion steering system for a motor vehicle.

14. The device according to claim 12, wherein the thrust piece is filled with lubricant.

15. The device according to claim 12, wherein the thrust piece includes, in an axial direction, at least two rows of depressions, by which at least two annular projections are formed to provide contact of the thrust piece with the housing.

16. The device according to claim 12, wherein positioned annularly about the circumference of the thrust piece are at least five depressions, by which at least five linear projections extending in an axial direction of the thrust piece are formed that provide contact of the thrust piece with the housing.

17. The device according to claim 12, wherein the spring is arranged as a flat-wire corrugated spring.

18. A device for pressing a gear rack against a pinion meshing with the gear rack, comprising:
a housing;
a flat-wire corrugated spring; and
a thrust piece that is loaded by the spring in a direction of the gear rack and is slidably guided in the housing.

19. The device according to claim 18, wherein the device is arranged in a rack-and-pinion steering system for a motor vehicle.

20. The device according to claim 18, wherein the spring is multilayered.

21. The device according to claim 18, wherein on a side facing away from the gear rack, the thrust piece includes a projection that engages with a central bore of the spring.

22. The device according to claim 18, wherein the thrust piece is arranged in a recess of the housing, the recess occluded by a setscrew that acts on the thrust piece by the spring, the spring arranged between the thrust piece and the setscrew.

23. The device according to claim 18, wherein the thrust piece is arranged as a sintered part having a plurality of depressions on a circumferential surface, regions of the circumferential surface elevated with respect to the depressions providing contact of the thrust piece with the housing.

24. A rack-and-pinion steering system, comprising:
a steering spindle;
a housing;
a gear rack displaceably supported in the housing;
a pinion connected to the steering spindle and meshing with the gear rack; and
a device adapted to press the gear rack against the pinion, the device including:
a spring; and
a thrust piece that is loaded by the spring in a direction of the gear rack and is slidably guided in the housing, the thrust piece arranged as a sintered part having a plurality of depressions on a circumferential surface, regions of the circumferential surface elevated with respect to the depressions providing a contact of the thrust piece with the housing.

25. The rack-and-pinion steering system according to claim 24, wherein the rack-and-pinion steering system is arranged as a rack-and-pinion steering system for a motor vehicle.

26. A rack-and-pinion steering system, comprising:
a steering spindle;
a housing;
a gear rack displaceably supported in the housing;
a pinion connected to the steering spindle and meshing with the gear rack; and
a device adapted to press the gear rack against the pinion, the device including:
a flat-wire corrugated spring; and
a thrust piece that is loaded by the spring in a direction of the gear rack and is slidably guided in the housing.

27. The rack-and-pinion steering system according to claim 26, wherein the rack-and-pinion steering system is arranged as a rack-and-pinion steering system for a motor vehicle.
